(19) United States
(12) Patent Application Publication
(10) Pub. No.: US 2026/0287719 A1
(43) Pub. Date: Sep. 24, 2026

(54) TUNEABLE LIDAR SYSTEMS AND RELATED METHODS

(71) Applicant: The Government of the United States of America, as represented by the Secretary of the Navy, Arlington, VA (US)

(72) Inventors: Jesse A. Frantz, Washington, DC (US); Cobey L. McGinnis, Springfield, VA (US); Jason D. Myers, Alexandria, VA (US); Anthony R. Clabeau, Westminster, CA (US); Jasbinder S. Sanghera, Ashburn, VA (US); Kenneth J. Ewing, Edgewater, MD (US); Matthew B. Hart, Silver Spring, MD (US); Abbie T. Watnik, Washington, DC (US)

(73) Assignee: The Government of the United States of America, as represented by the Secretary of the Navy, Arlington, VA (US)

(21) Appl. No.: 19/036,693

(22) Filed: Jan. 24, 2025

Related U.S. Application Data
(60) Provisional application No. 63/625,794, filed on Jan. 26, 2024.

(51) Int. Cl. G01S 7/481; G01S 17/10

(52) U.S. Cl. CPC G01S 7/4814; G01S 17/10

(57) ABSTRACT

According to some embodiments of the present disclosure, a method of operating a tuneable light detection and ranging (LIDAR) system. A plurality of laser outputs are transmitted from the LIDAR system, and each of the plurality of laser outputs has a respective laser wavelength such that each of the plurality of laser outputs has a different laser wavelength. A respective plurality of return signals resulting from the plurality of laser outputs are detected, and one of the laser wavelengths is selected based on the plurality of return signals. After selecting the one of the laser wavelengths, light detection and ranging are performed using the selected one of the laser wavelengths. Related LIDAR systems are also disclosed.

### CROSS-REFERENCE TO RELATED APPLICATIONS

This Application is a Nonprovisional Utility Patent Application and claims the benefit of priority under 35 U.S.C. Sec. 119 based on U.S. Provisional Patent Application No. 63/625,794 filed on Jan. 26, 2024. The disclosure of Provisional Application No. 63/625,794 and all references cited herein are hereby incorporated in their entirety by reference into the present disclosure.

### FEDERALLY SPONSORED RESEARCH AND DEVELOPMENT

The United States Government has ownership rights in this invention. Licensing inquiries may be directed to Office of Technology Transfer, US Naval Research Laboratory, Code 1004, Washington, D.C. 20375, USA; +1.202.767.7230; nrltechtran@us.navy.mil, referencing Navy Case #211972-US2.

### TECHNICAL FIELD

The present disclosure relates to Light Detection and Ranging (LIDAR) and related methods.

### BACKGROUND OF THE INVENTION

Light Detection and Ranging (LIDAR) is a technique in which a laser pulse is reflected from a surface and the delay in the return (reflected) pulse arriving at a detector in the LIDAR system provides information about the surface. LIDAR may be applied in a variety of applications including range finding, autonomous vehicle navigation, and three-dimensional mapping.

One practical challenge in applying the LIDAR technique may occur when a cloud of scattering particles obstructs the path of the laser beam. When the size of a particle is greater than the wavelength of visible light λᵥᵢₛ, the particle may cause scattering of visible light, and when concentrations of such particles are greater than about 3 g/m³, a degraded visual environment DVE (e.g., a brown out condition) may occur. This situation may occur, for example, in the case of a cloud of sand or dust blowing in air. Scattering from such a cloud may be strong enough that, in some cases, the return signal at the detector is too weak for a useful LIDAR signal to be collected.

An approach to address this problem is to use a laser with a high peak power where, despite the high magnitude of scattering, enough light may return from the surface of interest to the detector in order to carry out LIDAR ranging and/or imaging. However, in sufficiently strong scattering conditions, even a high-power pulse may be attenuated to an extent that lidar sensing is difficult/impossible.

Accordingly, there continues to exist a need in the art for improved LIDAR systems and methods.

### SUMMARY OF THE INVENTION

This summary is intended to introduce in simplified form, a selection of concepts that are further described in the Detailed Description. This summary is not intended to identify key or essential features of the claimed subject matter, nor is it intended to be used as an aid in determining the scope of the claimed subject matter. Instead, it is merely presented as a brief overview of the subject matter described and claimed herein.

According to some embodiments of inventive concepts, a method of operating a tuneable light detection and ranging (LIDAR) system is provided. A plurality of laser outputs are transmitted from the LIDAR system, and each of the plurality of laser outputs has a respective laser wavelength such that each of the plurality of laser outputs has a different laser wavelength. A respective plurality of return signals resulting from the plurality of laser outputs are detected, and one of the laser wavelengths is selected based on the plurality of return signals. After selecting the one of the laser wavelengths, light detection and ranging is performed using the selected one of the laser wavelengths.

According to some other embodiments of inventive concepts, a method of operating a tuneable light detection and ranging (LIDAR) system is provided. Light detection and ranging is performed using a first laser wavelength of the LIDAR system. After performing light detection and ranging using the first laser wavelength, light detection and ranging are performed using a second laser wavelength of the LIDAR system, wherein the second wavelength is different than the first laser wavelength.

According to still other embodiments of inventive concepts, a tuneable light detection and ranging (LIDAR) includes a tuneable laser, a detector, and a controller. The tuneable laser is configured to generate a plurality of laser outputs, and each of the plurality of laser outputs has a respective laser wavelength such that each of the plurality of laser outputs has a different laser wavelength. The detector is configured to detect return signals resulting from the plurality of laser outputs. The controller is coupled with the tuneable laser and with the detector. The controller is configured to control the LIDAR system to transmit a plurality of laser outputs from the LIDAR system, wherein each of the plurality of laser outputs has a respective laser wavelength such that each of the plurality of laser outputs has a different laser wavelength. The controller is further configured to detect a respective plurality of return signals resulting from the plurality of laser outputs. In addition, the controller is configured to select one of the laser wavelengths based on the plurality of return signals, and after selecting the one of the laser wavelengths, to perform light detection and ranging using the selected one of the laser wavelengths.

According to yet other embodiments of inventive concepts, a tuneable light detection and ranging (LIDAR) system includes a tuneable laser, a detector, and a controller coupled with the tuneable laser and with the detector. The tuneable laser is configured to generate a plurality of laser outputs, wherein each of the plurality of laser outputs has a respective laser wavelength such that each of the plurality of laser outputs has a different laser wavelength. The detector is configured to detect return signals resulting from the plurality of laser outputs. The controller is configured to control the LIDAR system to perform light detection and ranging using a first laser wavelength of the LIDAR system. After performing light detection and ranging using the first laser wavelength, the controller is configured to perform light detection and ranging using a second laser wavelength of the LIDAR system, wherein the second wavelength is different than the first laser wavelength.

### BRIEF DESCRIPTION OF DRAWINGS

Examples of embodiments of inventive concepts may be more clearly understood from the following detailed description taken in conjunction with the accompanying drawings in which:

FIG. 1A is a block diagram illustrating a tuneable light detection and ranging (LIDAR) system according to some embodiments of inventive concepts;

FIG. 1B is a block diagram of a controller of the tuneable LIDAR system of FIG. 1A according to some embodiments of inventive concepts;

FIG. 2A-1 is a graph of a fixed wavelength of a laser output for a LIDAR system;

FIG. 2A-2 is a diagram illustrating a LIDAR system using the fixed wavelength of FIG. 2A-1;

FIG. 2B-1 is a graph of a tuneable wavelength of a laser output for a LIDAR system according to some embodiments of inventive concepts;

FIG. 2B-2 is a diagram illustrating a tuneable LIDAR system using the tuneable wavelength of FIG. 2B-1 according to some embodiments of inventive concepts;

FIG. 3A is a diagram of a chamber including a hopper and mesh used to test tuneable LIDAR systems according to some embodiments of inventive concepts;

FIG. 3B is a top view of the mesh and hopper of FIG. 3A according to some embodiments of inventive concepts;

FIG. 4 is a graph illustrating transmission through three different samples of falling sand over a range of tuneable wavelengths using the chamber of FIG. 3A according to some embodiments of inventive concepts;

FIG. 5 is a flow chart illustrating operations of the LIDAR system of FIGS. 1A and 1B according to some embodiments of inventive concepts; and

FIG. 6 is a flow chart illustrating operations of the LIDAR system of FIGS. 1A and 1B according to some embodiments of inventive concepts.

### DETAILED DESCRIPTION

Aspects and features of the present disclosure will now be described more fully with reference to the accompanying drawings. The following description shows, by way of example, combinations and configurations in which aspects, features, and embodiments of inventive concepts can be put into practice. It will be understood that the disclosed aspects, features, and/or embodiments are merely examples, and that one skilled in the art may use other aspects, features, and/or embodiments or make functional and/or structural modifications without departing from the scope of the present disclosure. Moreover, like reference numerals refer to like elements throughout, and sizes of each of the elements may be exaggerated for clarity and conveniences of explanation.

Some embodiments of inventive concepts provide a LIDAR system that performs LIDAR measurements through a cloud of scattering particles (e.g., sand) using a laser with a wavelength that can be tuned for emission at or near a Christiansen wavelength of the particles.

An approach to address the problem of scattering particles may be provided based on a phenomenon known as the Christiansen effect. The Christiansen effect phenomenon occurs when the refractive index of particles matches that of the medium they are surrounded by at a particular wavelength, dramatically reducing scattering. The Christiansen effect has been used to make optical filters in which a crystalline powder is dispersed in an organic liquid, and as a result of the dissimilar dispersion of the powder and the liquid, the filter exhibits high transmittance for a limited bandwidth and high scattering elsewhere, making it an effective bandpass filter as discussed in Reference [1].

The Christiansen effect can also be applied to particles in air, provided that a Christiansen wavelength, λ_{c}, exists at which the refractive index of the particles and air match. For sand particles (which are largely composed of silica) in air, for example, the refractive index of the sand particles, nₛ is approximately 1.5 in the visible and shortwave infrared wavelengths. For visible and near infrared wavelengths, the mismatch of the refractive index of silica/sand with that of air (nₐ≈1), may result in significant scattering, best described by Mie theory. Due to anomalous dispersion, nₛ for silicate materials decreases with wavelength in the infrared while nₐ remains constant. At λ_{c}, nₛ≈1, so that nₛ=nₐ, thereby rendering the particles substantially invisible and/or reducing/minimizing scattering. For pure silica in air, λ_{c} may vary from about 7.0 μm to about 8.5 μm (e.g., λ_{c}≈7.5 μm).

In an idealized case, λ_{c} may occur at a single, fixed wavelength, but in practice sand is a mixture of many compounds, grain sizes, and shapes, so that λ_{c} for sand may vary from approximately 7.0 μm to 8.5 μm, as discussed, for example, in References [2] and [3]. In silicate materials, λ_{c} may typically occur in a region of low, but nonzero, absorption. The separation between the nearby absorption peak and the Christiansen feature may be due to the fact that the absorption peak is red-shifted with respect to the dip in refractive index, as can be understood from the point of view of Kramers-Kronig consistency, as discussed, for example, in References [4] and [5].

The Christiansen effect can thus be applied to reduce/minimize scattering to provide improved LIDAR measurements in the presence of a cloud of scatterers. In the case of silicate sand in air, this may be accomplished using LIDAR with a laser having an emission wavelength in the range of about 7.5 μm to about 8.5 μm. The LIDAR laser may be chosen to operate at an emission wavelength of λ_{c} that is chosen for a particular scatterer, or optionally, the LIDAR laser may be tuneable about this wavelength. In addition to silicate sand in air, some embodiments of inventive concepts may be applied in any instance where LIDAR is to be performed in the presence of scattering particles, as long as a Christiansen wavelength exists.

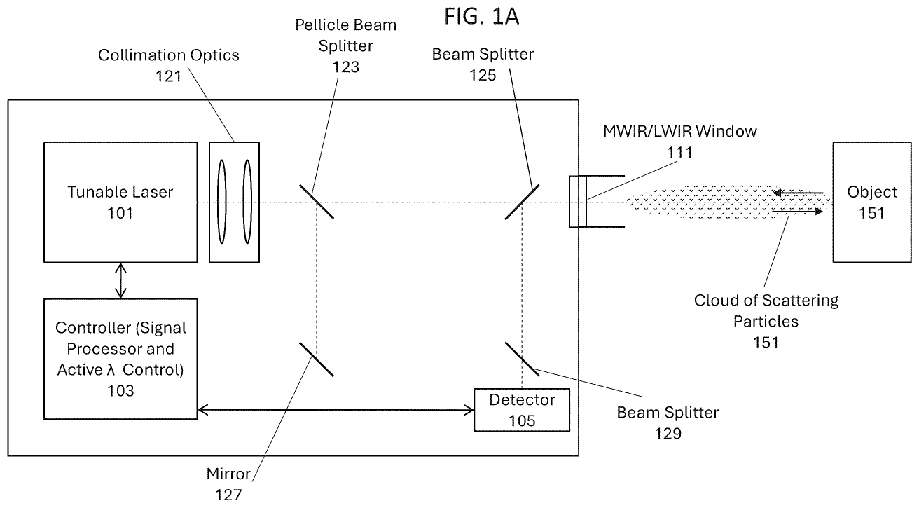

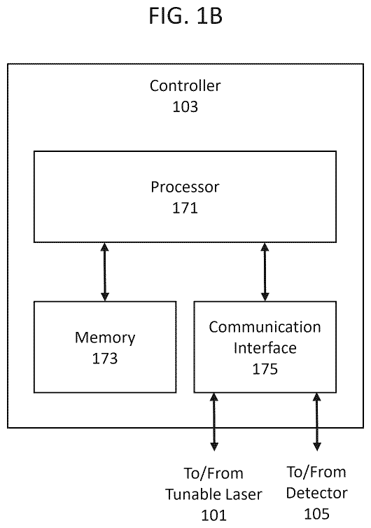

According to some embodiments of inventive concepts shown in FIG. 1A, a LIDAR system may include tuneable laser 101, operating at wavelength/c for particles of a particular composition suspended in a medium, a detector 105 that is sensitive at wavelength 1c, optical components (e.g., pellicle beam splitter (BS) 123, beam splitter 125, mirror 127, and beam splitter 129) to manipulate light, and controller 103 to process the signal from detector 105 and/or to control tuneable laser 101.

In embodiments of FIG. 1A, the LIDAR system includes laser 101 that may be tuneable in the range of about 7.5 μm wavelength to about 8.5 μm wavelength such as a tuneable quantum cascade laser (QCL) capable of emitting pulses with pulse times/durations between about 0.1 ns and several tens of ns. The LIDAR system of FIG. 1A also includes a pellicle beam splitter (BS) 123, two additional beam splitters 125 and 129, mirror 127, and optical window 111, all of which are chosen to function in the 7.5 μm to 8.5 μm wavelength range. Light that exits optical window 111 passes through a cloud of scattering particles 151 (e.g., sand), is reflected from a surface of object 151, and returns through the cloud of scattering particles 151 and optical window 111, and some fraction of this light is directed onto detector 105. Detector 105 may be provided, for example, using a single-pixel mercury cadmium telluride (MCT) detector with a rise time that is fast enough to detect pulses with pulse times/durations between 0.1 ns and several tens of ns. Finally, controller 103 of the LIDAR system may include a computer and/or processing electronics used to control tuneable laser 101, and optionally tune a wavelength of tuneable laser 101, as well as process return signals from detector 105.

As further shown in FIG. 1B, controller 103 (also referred to as a signal processor) may include processor 171 (also referred to as processing circuitry), memory 173 (also referred to as memory circuitry), and communication interface 175 (also referred to as communication circuitry). Communication interface 175 is coupled with tuneable laser 101 and with detector 105 of the tuneable LIDAR system. Processor 171 is coupled with memory 173, and memory 173 may include computer readable program code that when executed by processor 171 causes processor 171 to perform operations according to embodiments disclosed herein. Accordingly, processor 171 may execute computer readable program code of memory 173 to perform operations as disclosed herein. According to other embodiments, processor 171 may be defined to include memory so that separate memory is not required. Accordingly, processor 171 can transmit instructions through communication interface 101 to control tuneable laser 101, and processor 171 can receive information from detector 105 regarding return signals.

In embodiments of FIGS. 1A and 1B, during operation, a pulse train is emitted from the tuneable laser 101 through collimation optics 121. The signal is split by pellicle beam splitter 123. Some of the light from pellicle beam splitter 123 is directed outward through beam splitter 125, optical window 111, and cloud 151 (of scattering particles) towards the surface of target object 151 (delayed pulses), while some of the light from pellicle beam splitter 123 is maintained locally within the LIDAR system (local pulses). More particularly, the local pulses are reflected by pellicle beam splitter 123, mirror 127, and beam splitter 129 toward detector 105. Light reflected from the surface of target object 151 returns to the LIDAR system through cloud 151 and window 111 and is directed by beam splitters 125 and 129 to detector 105.

Detector 105 may generate a detection signal based on interaction of the reflected/delayed pulses (received through window 111, beam splitter 125, and beam splitter 129) and source pulses (received through beam splitter 123, mirror 127, and beam splitter 129). Detector 105 may then provide the detection signal to controller 103. More particularly, the detection signal may be received at processor 171 through communication interface 175.

Detector 105 and/or processor 171 may carry out processing to subtract extraneous signals (e.g., residual reflections from scattering by the sand). A time difference between the delayed and local pulses can then be used to determine the distance from the LIDAR system to the surface of object 151. When using tuneable laser 101, processor 171 may use a control loop to increase/maximize the return signal through the scattering media of cloud 151 by adjusting the laser emission wavelength. This wavelength may be controlled actively and changed in time to account for changing properties of the scattering medium of cloud 151. More particularly, processor 151 may implement this control loop by transmitting laser control signalling through communication interface 175 to tuneable laser 101.

According to other embodiments of inventive concepts, light exiting the LIDAR system through window 111 may be scanned in one or two dimensions (e.g., using gimbal-mounted mirrors) to perform surface mapping of object 151. According to still other embodiments, detector 105 may be provided using one or more of a camera and/or a detector array to enable surface mapping.

In FIG. 1A, tuneable laser 101, for example, may have a wavelength that is tuneable in the range of about 7.0 μm to about 8.5 μm; a linewidth less than about 1 cm⁻¹, an average power greater than about 500 mW, and a repetition rate in the range of about 0.1 kHz to about 1 MHz. Detector 105, for example, provide a specific detectivity greater than 2.5×10⁹ cmHz^{1/2}/W, a rise time of about 3 ns, and uncooled or cooled operation. The LIDAR system of FIGS. 1A and 1B can thus provide active wavelength tuning of the laser output from tuneable laser 101 to provide increased/peak transmittance through cloud 151, and tuning may vary continually to adapt to changing conditions of cloud 151.

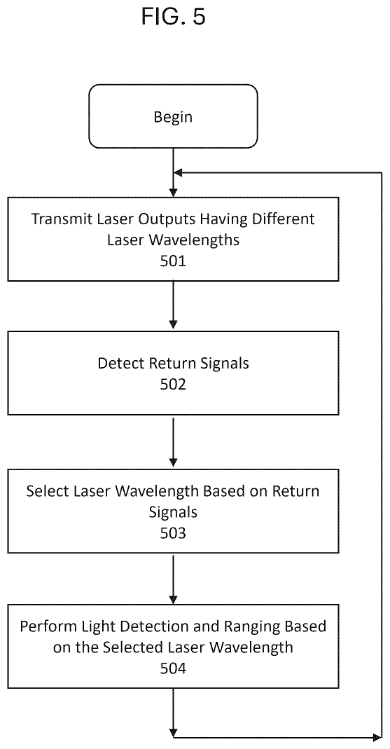

Operations of the LIDAR system of FIGS. 1A and 1B will now be discussed with respect to the flow chart of FIG. 5 according to some embodiments of inventive concepts. As discussed above, the tuneable LIDAR system of FIGS. 1A and 1B includes tuneable laser 101, detector 105, and controller 103 that is coupled with tuneable laser 101 and detector 105. Tuneable laser 101 is configured to generate a plurality of laser outputs, wherein each of the plurality of laser outputs has a respective laser wavelength such that each of the plurality of laser outputs has a different laser wavelength. Detector 105 is configured to detect return signals resulting from the plurality of laser outputs. Controller 103 is configured to control the LIDAR according to operations discussed below with respect to FIG. 5.

At block 501, controller 103 is configured to control tuneable laser 101 to transmit a plurality of laser outputs from the LIDAR system, wherein each of the plurality of laser outputs has a respective laser wavelength such that each of the plurality of laser outputs has a different laser wavelength. For example, processor 171 may transmit control signaling to tuneable laser 101 through communication interface 175 based on computer readable program code from memory 173. The plurality of laser outputs may be transmitted sequentially or at the same time.

At block 502, controller 103 is configured to detect a respective plurality of return signals resulting from the plurality of laser outputs based on signaling from detector 105. For example, processor 171 may receive detection signaling from detector 101 through communication interface 175 based on computer readable program code from memory 173.

At block 503, controller 103 is configured to select one of the laser wavelengths based on the plurality of return signals. For example, processor 171 may select the laser wavelength based on the detection signaling and based on computer readable program code from memory 173. For example, controller 103 may be configured to select the laser wavelength based on comparing strengths of the plurality of return signals.

At block 504 after selecting the laser wavelength, controller 103 controls tuneable laser 101 to perform light detection and ranging using the selected one of the laser wavelengths.

As indicated by the arrow returning from block 504 to block 501, operations of FIG. 5 may be repeated to provide continuous tuning of the wavelength of tuneable laser 101 to adapt to changing conditions in the environment. For example, controller 103 may control tuneable laser 101 to change the wavelength to adapt to clear weather, fog, rain, snow, smog, smoke, sand, dust, etc.

According to some embodiments of FIG. 5, block 501 may include controller 103 controlling tuneable laser 101 to transmit first and second laser outputs from the LIDAR system, with the first laser output having a first laser wavelength and the second laser output having a second laser wavelength different than the first laser wavelength. Block 502 may thus include controller 103 and/or detector 105 detecting a first return signal resulting from the first laser output and detecting a second return signal resulting from the second laser output. Block 503 then includes controller 103 selecting one of the first and second laser wavelengths based on the first and second return signals, and block 504 includes performing light detection and ranging using the selected one of the first and second laser wavelengths.

According to some embodiments of FIG. 5, the first wavelength may be less than about 5000 nanometers (nm) and the second wavelength is greater than about 6000 nanometers (nm). The first wavelength, for example, may be in a range of about 500 nm to about 4000 nm (e.g., in a range of about 800 nm to about 3000 nm), and more particularly, the first wavelength may be selected from one of about 905 nm, about 1550 nm, and/or about 2800 nm. The second wavelength, for example, may be in a range of about 6000 nm to about 9,000 nm (e.g., in a range of about 6000 nm to about 7000 nm, or in a range of about 7000 nm to about 9000 nm).

According to some embodiments of FIG. 5, block 503 may include selecting the one of the first and second laser wavelengths based on comparing strengths of the first and second return signals.

According to embodiments of FIG. 5, any number of two or more laser outputs having different wavelengths may be transmitted at block 501 and corresponding return signals for each of the two or more laser outputs can be received at block 502.

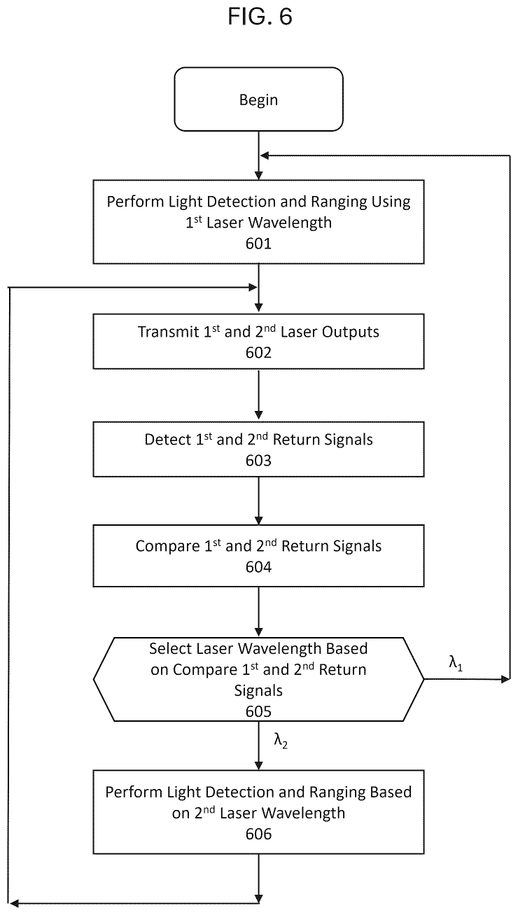

Operations of the LIDAR system of FIGS. 1A and 1B will now be discussed with respect to the flow chart of FIG. 6 according to some other embodiments of inventive concepts. As discussed above, the tuneable LIDAR system of FIGS. 1A and 1B includes tunaeble laser 101, detector 105, and controller 103 coupled with tuneable laser 101 and detector 105. Tuneable laser 101 is configured to generate a plurality of laser outputs, wherein each of the plurality of laser outputs has a respective laser wavelength such that each of the plurality of laser outputs has different laser wavelength. Detector 105 is configured to detect return signals resulting from the plurality of laser outputs. Controller 103 is configured to control the LIDAR according to operations discussed below with respect to FIG. 6.

At block 601, controller 103 is configured to control tuneable laser 101 and/or detector 105 to perform light detection and ranging using a first laser wavelength 21. For example, processor 171 may transmit control signaling to tuneable laser 101 through communication interface 175 based on computer readable program code from memory 173 to transmit a first laser output having the first laser wavelength, and processor 171 may receive signaling from detector 105 through communication interface 175 based on computer readable program code from memory 173 to detect a return signal corresponding to the first laser output.

At block 602, controller 103 is configured to control tuneable laser 101 to transmit first and second laser outputs from the LIDAR system, with the first laser output having the first wavelength 2, with the second laser output having the second wavelength 22, and with the first and second wavelengths being different. For example, processor 171 may transmit control signaling to tuneable laser 101 through communication interface 175 based on computer readable program code in memory 173 to transmit the first and second laser outputs.

At block 603, controller 103 is configured to control detector 105 to detect a first return signal having the first wavelength resulting from the first laser output and a second return signal having the second wavelength resulting from the second laser output. For example, processor 171 may receive detection signaling from detector 105 through communication interface 175 based on computer readable program code in memory 173.

At block 604, controller 103 is configured to compare the first and second return signals. For example, processor 171 may compare the first and second return signals based on computer readable program code in memory 173.

At block 605, controller 103 is configured to select one of the first and second wavelengths based on respective strengths of the return signals (e.g., selecting the strongest of the return signals). For example, processor 171 may select the wavelength based on computer readable program code in memory 173.

Responsive to selecting the first wavelength at block 605, controller 103 is configured to control tuneable laser 101 and/or detector 105 to continue performing light detection and ranging using the first laser wavelength. For example, processor 171 may transmit control signaling to tuneable laser 101 through communication interface 175 based on computer readable program code from memory 173 to transmit a first laser output having the first laser wavelength, and processor 171 may receive signaling from detector 105 through communication interface 175 based on computer readable program code from memory 173 to detect a return signal corresponding to the first laser output.

Responsive to selecting the second wavelength at block 605, controller 103 is configured to control tuneable laser 101 and/or detector 105 to perform light detection and ranging using the second laser wavelength. For example, processor 171 may transmit control signaling to tuneable laser 101 through communication interface 175 based on computer readable program code from memory 173 to transmit the second laser output having the second laser wavelength, and processor 171 may receive signaling from detector 105 through communication interface 175 based on computer readable program code from memory 173 to detect a return signal corresponding to the second laser output.

According to some embodiments of FIG. 6, the first wavelength may be less than about 5000 nanometers (nm), and the second wavelength may be greater than about 6000 nanometers (nm). For example, the first wavelength may be in a range of about 500 nm to about 4000 nm (e.g., in a range of about 800 nm to about 3000 nm), and more particularly, the first wavelength may be selected from one of about 905 nm, about 1550 nm, and/or about 2800 nm. The second wavelength may be in a range of about 6000 nm to about 9,000 nm (e.g., in a range of about 6000 nm to about 7000 nm or in a range of about 7000 nm to about 9000 nm).

As will be understood, any plurality of two or more laser outputs having different wavelengths may be transmitted at block 602, and corresponding return signals for each of the plurality of laser outputs may be detected at block 603 and compared at block 604. At block 605 one of the plurality of wavelengths is selected (e.g., based on signal strength), and light detection and ranging is performed using the selected wavelength.

According to some other embodiments of inventive concepts, operations of blocks 602, 603, and 604 may be omitted and controller 103 may select the wavelength based on user input. Stated in other words, a user may select from one of a plurality of wavelengths that is used to perform light detection and ranging.

According to still other embodiments of inventive concepts, operations of blocks 602, 603, and 604 may be omitted, and at block 605, controller 103 may select a different wavelength (e.g., the second wavelength when the first wavelength is currently being used at block 601) responsive to a return signal of the first wavelength falling below a threshold.

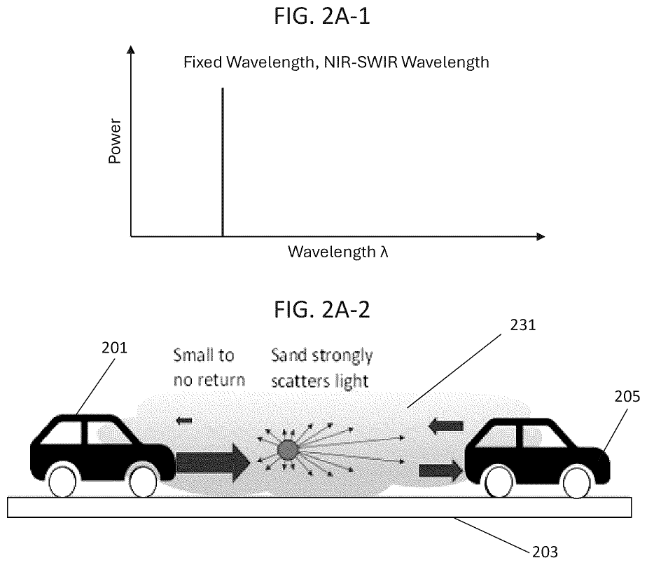

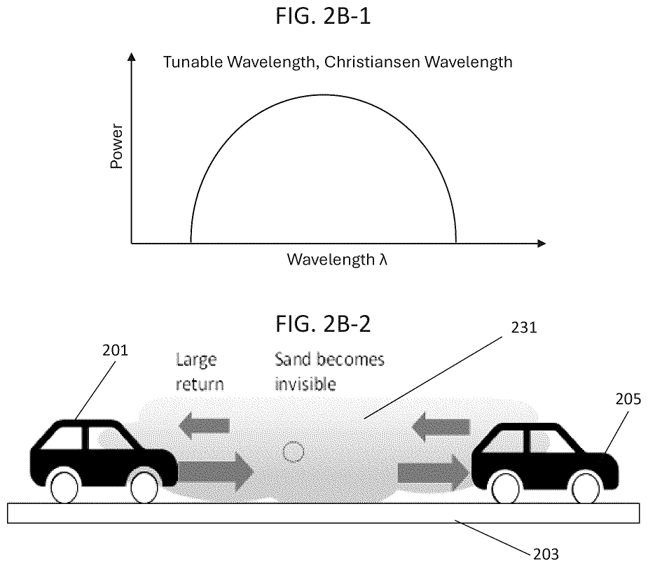

FIGS. 2A-1 and 2A-2 illustrate use of a LIDAR system that operates without tuning to a Christiansen wavelength, and FIGS. 2B-1 and 2B-2 illustrate use of a LIDAR system that operates with tuning to a Christiansen wavelength according to some embodiments of inventive concepts. In each of FIGS. 2A-2 and 2B-2, first vehicle 201 is located on road 103, and second vehicle 205 is located in front of first vehicle 201, with a sand cloud 231 (scattering medium) between vehicles 201 and 205 resulting in poor visibility. In FIG. 2A-2, vehicle 201 includes the LIDAR system that operates without tuning to a Christiansen wavelength. In FIG. 2B-2, vehicle 201 includes the LIDAR system of FIGS. 1A and 1B that that operates with tuning to a Christiansen wavelength.

In the example of FIGS. 2A-1 and 2A-2, using the LIDAR system without tuning to a Christiansen wavelength, sand cloud 231 scatters the laser light from the LIDAR system, resulting in a weak return signal back to the first vehicle 201, potentially making LIDAR measurement unreliable/impossible in a degraded visual environment DVE. In the example of FIGS. 2B-1 and 2B-2, the LIDAR system is tuned to operate at wavelength λ_{c} for the sand cloud 231, either at a fixed wavelength or tuning across a wavelength range that enables improvement/optimization of the return signal. Accordingly, the LIDAR system of FIGS. 2B-1 and 2B-2 can penetrate the degraded visual environment DVE of a dust cloud by operating at the Christensen wavelength λ_{c} at which the refractive index of a given obscurant matches that of the surrounding medium, permitting a sufficient return signal that may be unavailable at other wavelengths.

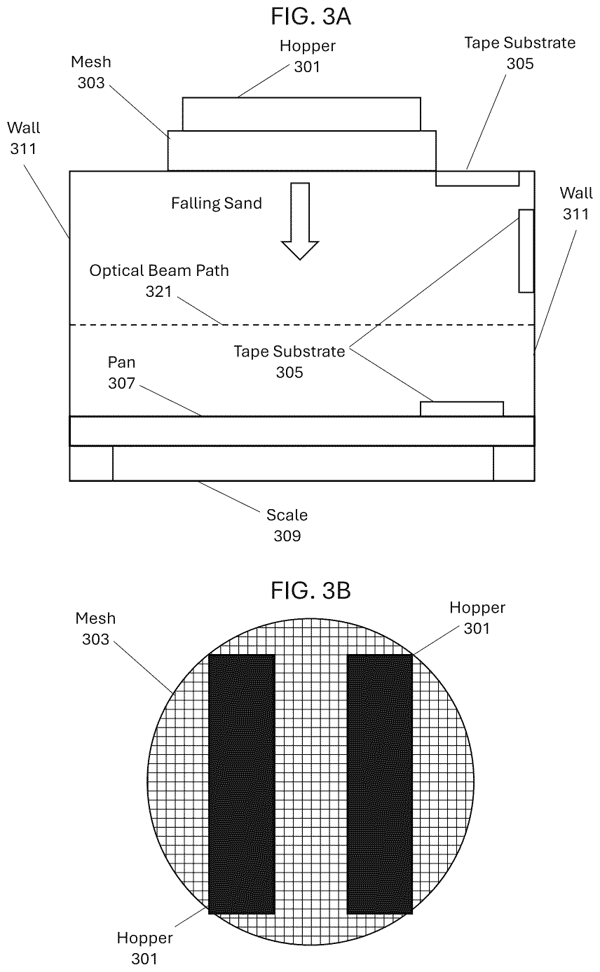

Embodiments of inventive concepts have been simulated using laboratory measurements. To carry out these measurements, a sand test chamber was constructed. The sand test chamber, illustrated in FIGS. 3A and 3B, includes plexiglass walls 311, hopper 301 (e.g., formed by 3-Dimensional printing), steel mesh 303 of mesh size No. 18 (1 mm), tape substrate(s) 305, metal low-profile pan 307, and low-profile scale 309. Each tape substrate 305 may be provided to capture a sample of the sand so that it can be analyzed (e.g., to measure a composition of the sand that falls to that location). Desert sand samples, gathered from different locations, and labeled “Sand 1,” “Sand 2,” and “Sand 3,” were dispensed by placing them in the hopper 301 and then vibrating the hopper 301 causing the sand to fall through the mesh 303, forming a “curtain,” approximately ½″ in thickness, orthogonal to an optical beam path 321. The chamber ensured that the plume of finer particles created from the falling sand was constrained to a volume that still interacted with the optical beam path 321. The 3D printed hopper 301 had exit dimensions of 13.97 cm×1.27 cm and was used to increase the duration of time that the sand fell. The low-profile scale 309 allowed the final weight of the fallen sand to be measured, enabling the density of falling sand in the optical path to be calculated after each run.

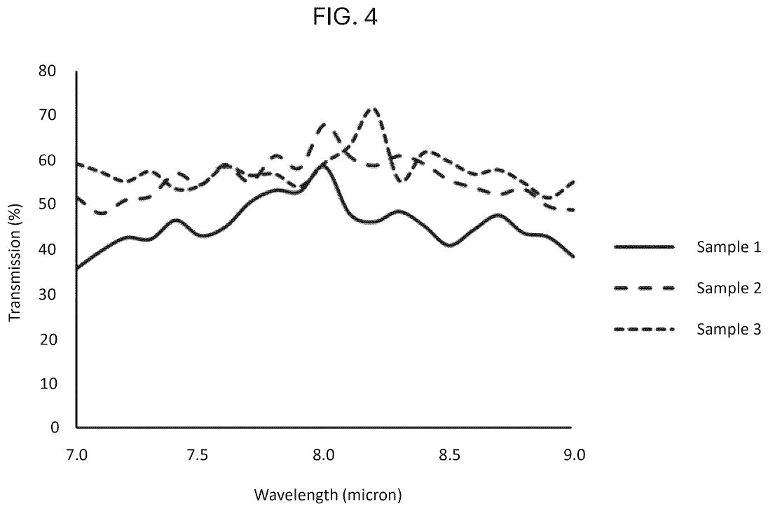

Each run lasted approximately 1 minute. The density of the falling sand for each sample was found to be 90.8±37.2 g/m³ for Sand 1, 34.6±12.0 g/m³ for Sand 2, and 116.4±36.5 g/m³ for Sand 3. Transmission through the sand curtain was then measured using a tuneable quantum cascade laser QCL (Daylight Solutions Hedgehog), with emission wavelengths ranging from 6.83 microns to 9.26 microns. The optical beam path 321 was oriented orthogonal to the sand curtain. The QCL was tuned between 7 μm and 9 μm in increments of 0.1 μm. Light transmission through the sand curtain was measured using a broadband thermopile detector from OPHIR Photonics. The percent transmission was calculated by averaging the propagated intensity through the sand curtain at each wavelength individually and then dividing by the propagated intensity at each wavelength without the sand curtain in the beam path. FIG. 4 is a graph showing transmission as a function of wavelength, indicating that a maximum in transmittance occurs for all three samples at a wavelength near 8 μm, corresponding to λ_{c} for these sand samples.

Some embodiments of inventive concepts disclosed herein may provide one or more of the following advantages and/or features. Some embodiments of inventive concepts may provide methods to perform LIDAR in situations where it may not otherwise be possible owing to weak return signals caused by scattering from particles in the laser beam path. Some embodiments of inventive concepts may provide tuning of the LIDAR laser source to compensate for variations in λ_{c} for a given obscurant cloud to increase/maximize the return signal. Some embodiments of inventive concepts may be used in applications including one or more of: Range finding, Autonomous vehicle navigation, Topographic mapping, and/or agricultural mapping.

Additional embodiments of inventive concepts are discussed below. According to some embodiments, the LIDAR laser may be tuned to operate at an emission wavelength near 2.8 μm in order to take advantage of Christiansen wavelengths for water and/or ice in air. According to some embodiments, the LIDAR laser may be tuned to operate at a different emission wavelength in order to take advantage of Christiansen wavelengths for other particulate samples in air (e.g., smoke, smog, and/or non-silicate dust). According to some embodiments, the LIDAR laser may be tuned to operate at a different emission wavelength in order to take advantage of Christiansen wavelengths for particulate samples in a medium other than air such as a different gas or water.

According to some embodiments, the LIDAR system may include components to compress the output pulse, resulting in a shorter duration for each pulse. According to some embodiments, light exiting the LIDAR system may be scanned in one or two dimensions, for example, by using gimbal-mounted mirrors and/or micro-electromechanical systems (MEMS) mirrors, in order to perform mapping. According to some embodiments, a spinning configuration, in which the entire LIDAR system is rotated by a motor, may be used in order to scan the LIDAR in one dimension. According to some embodiments, the single-pixel MCT detector may be replaced with a camera and/or detector array in order to perform mapping. According to some embodiments, a LIDAR laser (other than a QCL) that operates in a suitable wavelength range and with suitable pulse characteristics could be used.

Additional Embodiments are discussed below.

Embodiment 1. A method of operating a tuneable light detection and ranging (LIDAR) system, the method comprising: transmitting a plurality of laser outputs from the LIDAR system, wherein each of the plurality of laser outputs has a respective laser wavelength such that each of the plurality of laser outputs has a different laser wavelength; detecting a respective plurality of return signals resulting from the plurality of laser outputs; selecting one of the laser wavelengths based on the plurality of return signals; and after selecting the one of the laser wavelengths, performing light detection and ranging using the selected one of the laser wavelengths.

Embodiment 2. The method of Embodiment 1, wherein transmitting the plurality of laser outputs comprises transmitting first and second laser outputs from the LIDAR system wherein the first laser output has a first laser wavelength and wherein the second laser output has a second laser wavelength different than the first laser wavelength, wherein detecting the respective return signals comprises detecting a first return signal resulting from the first laser output and detecting a second return signal resulting from the second laser output, wherein selecting the one of the plurality of laser wavelengths comprises selecting one of the first and second laser wavelengths based on the first and second return signals, and wherein performing light detection and ranging comprises performing light detection and ranging using the selected one of the first and second laser wavelengths.

Embodiment 3. The method of Embodiment 2, wherein the first wavelength is less than about 5000 nanometers (nm) and the second wavelength is greater than about 6000 nanometers (nm).

Embodiment 4. The method of Embodiment 3, wherein the first wavelength is in a range of about 500 nm to about 4000 nm.

Embodiment 5. The method of Embodiment 4, wherein the first wavelength is in a range of about 800 nm to about 3000 nm.

Embodiment 6. The method of Embodiment 5, wherein the first wavelength is selected from one of about 905 nm, about 1550 nm, and about 2800 nm.

Embodiment 7. The method of Embodiment 3, wherein the second wavelength is in a range of about 6000 nm to about 9,000 nm.

Embodiment 8. The method of Embodiment 7, wherein the second wavelength is in a range of about 6000 nm to about 7000 nm or in a range of about 7000 nm to about 9000 nm.

Embodiment 9. The method of Embodiment 3, wherein selecting the one of the first and second laser wavelengths comprises selecting the one of the first and second laser wavelengths based on comparing strengths of the first and second return signals.

Embodiment 10. The method of Embodiment 1, wherein selecting the one of the laser wavelengths comprises selecting the one of the laser wavelengths based on comparing strengths of the plurality of return signals.

Embodiment 11. The method of Embodiment 1, wherein transmitting the plurality of laser outputs comprises transmitting first, second, and third laser outputs from the LIDAR system, wherein the first laser output has a first laser wavelength, wherein the second laser output has a second laser wavelength different than the first laser wavelength, and wherein the third laser output has a third laser wavelength different than the first and second laser wavelengths, wherein detecting the respective plurality of return signals comprises detecting a first return signal resulting from the first laser output, detecting a second return signal resulting from the second laser output, and detecting a third return signal resulting from the third laser output, wherein selecting the one of the plurality of laser wavelengths comprises selecting one of the first, second, and third laser wavelengths based on the first, second, and third return signals, and wherein performing light detection and ranging comprises performing light detection and ranging using the selected one of the first, second, and third laser wavelengths.

Embodiment 12. A method of operating a tuneable light detection and ranging (LIDAR) system, the method comprising: performing light detection and ranging using a first laser wavelength of the LIDAR system; and after performing light detection and ranging using the first laser wavelength, performing light detection and ranging using a second laser wavelength of the LIDAR system, wherein the second wavelength is different than the first laser wavelength.

Embodiment 13. The method of Embodiment 12, wherein performing light detection and ranging using the second wavelength is responsive to a second user input selecting the second laser wavelength.

Embodiment 14. The method of Embodiment 12, wherein performing light detection and ranging using the second laser wavelength is responsive to a return signal of the first wavelength falling below a threshold.

Embodiment 15. The method of Embodiment 12 further comprising: before performing light detection and ranging using the second wavelength, transmitting first and second laser outputs from the LIDAR system, wherein the first laser output has the first wavelength and the second laser output as the second wavelength; before performing light detection and ranging using the second wavelength, detecting a first return signal resulting from the first laser output and a second return signal resulting from the second laser output; wherein performing light detection and ranging using the second laser wavelength is responsive to comparing the first and second return signals.

Embodiment 16. The method of Embodiment 15, wherein the performing light detection and ranging using the second laser wavelength is responsive to a strength of the second return signal exceeding a strength of the first return signal.

Embodiment 17. The method of Embodiment 12, wherein the first wavelength is less than about 5000 nanometers (nm) and the second wavelength is greater than about 6000 nanometers (nm).

Embodiment 18. The method of Embodiment 17, wherein the first wavelength is in a range of about 500 nm to about 4000 nm.

Embodiment 19. The method of Embodiment 18, wherein the first wavelength is in a range of about 800 nm to about 3000 nm.

Embodiment 20. The method of Embodiment 19, wherein the first wavelength is selected from one of about 905 nm, about 1550 nm, and about 2800 nm.

Embodiment 21. The method of Embodiment 17, wherein the second wavelength is in a range of about 6000 nm to about 9,000 nm.

Embodiment 22. The method of Embodiment 21, wherein the second wavelength is in a range of about 6000 nm to about 7000 nm or in a range of about 7000 nm to about 9000 nm.

Embodiment 23. A tuneable light detection and ranging (LIDAR) system comprising: a tuneable laser configured to generate a plurality of laser outputs, wherein each of the plurality of laser outputs has a respective laser wavelength such that each of the plurality of laser outputs has a different laser wavelength; a detector configured to detect return signals resulting from the plurality of laser outputs; a controller coupled with the tuneable laser and with the detector, wherein the controller is configured to control the LIDAR system to perform operations according to any of claims 1-22.

Embodiment 24. The tuneable LIDAR system of Embodiment 23, wherein the controller is configured to control the tuneable laser to transmit the plurality of laser outputs from the LIDAR system.

Embodiment 25. The tuneable LIDAR system of Embodiment 23, wherein the controller is configured to select the one of the plurality of laser wavelengths based on the detector detecting the return signals.

Embodiment 26. The tuneable LIDAR system of Embodiment 23, wherein the controller is configured to control the LIDAR system to perform light detection and ranging using the selected one of the laser wavelengths by controlling the tuneable to transmit a laser output at the selected one of the laser wavelengths and by receiving information from the detector regarding a return signal resulting from the laser output at the selected one of the laser wavelengths.

The following publications have been cited in the present disclosure, and the disclosures of each of these publications are hereby incorporated herein in their entireties by reference.
Reference [1]. BARNES, R. B., et al., “The Christiansen Filter Effect in the Infrared,” Phys. Rev. (US), Vol. 49, pages 732-740, 15 May 1936.
Reference [2]. CARLON, H. R., “Christiansen effect in IR spectra of soil-derived atmospheric dusts,” Appl. Opt. (US), Vol. 18, No. 21, pages 3610-3614, 1 Nov. 1979.
Reference [3]. COOPER, B. L., “Midinfrared spectral features of rocks and their powders,” J. Geophys. Res. (US), Vol. 107, No. E4, 5017, 17 pages, 11 Apr. 2002.
Reference [4]. YAMAMOTO, K., et al., “Kramers-Kronig analysis applied to reflection-absorption spectroscopy,” Vib. Spectrosc. (NL), Vol. 15, Issue 1, pages 27-36, August 1997.
Reference [5]. KITAMURA, R., et al., “Optical constants of silica glass from extreme ultraviolet to far infrared at near room temperature,” Appl. Opt. (US), Vol. 46, No. 33, pages 8118-8133, 19 Nov. 2007.

The terminology used herein is for the purpose of describing particular embodiments only and is not intended to be limiting of inventive concepts. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof. The term “and/or” includes any and all combinations of one or more of the associated listed items.

It will be understood that, although the terms first, second, third, etc. may be used herein to describe various elements, these elements should not be limited by these terms. These terms are only used to distinguish one element from another element. Thus, a first element discussed herein could be termed a second element without departing from the scope of the present inventive concepts.

It will also be understood that when an element is referred to as being “coupled” to/with or “connected” to/with another element, it can be directly coupled or connected to/with the other element, or intervening elements may be present. In contrast, when an element is referred to as being “directly coupled” to/with or “directly connected” to/with another element, there are no intervening elements present. Similarly, when an operation/element is referred to as being “responsive to” or “in response to” another event/operation/element, it can be directly responsive to or directly in response to the other operation/element or intervening events/operations/elements may be present. In contrast, when an operation/element is referred to as being “directly responsive to” or “directly in response to” another event/operation/element, there are no intervening events/operations/elements present.

Unless otherwise defined, all terms (including technical and scientific terms) used herein have the same meaning as commonly understood by one of ordinary skill in the art to which the inventive concepts herein belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The operations of any methods disclosed herein do not have to be performed in the exact order disclosed, unless an operation is explicitly described as following or preceding another operation and/or where it is implicit that an operation must follow or precede another operation. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the description herein.

While inventive concepts have been particularly shown and described with reference to examples of embodiments thereof, it will be understood that various changes in form and details may be made therein without departing from the spirit of the following claims.

1. A method of operating a tuneable light detection and ranging (LIDAR) system, the method comprising:
transmitting a plurality of laser outputs from the LIDAR system, wherein each of the plurality of laser outputs has a respective laser wavelength such that each of the plurality of laser outputs has a different laser wavelength;
detecting a respective plurality of return signals resulting from the plurality of laser outputs;
selecting one of the laser wavelengths based on the plurality of return signals; and
after selecting the one of the laser wavelengths, performing light detection and ranging using the selected one of the laser wavelengths.

2. The method of claim 1,
wherein transmitting the plurality of laser outputs comprises transmitting first and second laser outputs from the LIDAR system, wherein the first laser output has a first laser wavelength, and wherein the second laser output has a second laser wavelength different than the first laser wavelength,
wherein detecting the respective return signals comprises detecting a first return signal resulting from the first laser output, and detecting a second return signal resulting from the second laser output,
wherein selecting the one of the plurality of laser wavelengths comprises selecting one of the first and second laser wavelengths based on the first and second return signals, and
wherein performing light detection and ranging comprises performing light detection and ranging using the selected one of the first and second laser wavelengths.

3. The method of claim 2, wherein the first wavelength is less than about 5000 nanometers (nm) and the second wavelength is greater than about 6000 nanometers (nm).

4. The method of claim 3, wherein the first wavelength is in a range of about 500 nm to about 4000 nm.

5. The method of claim 3, wherein the second wavelength is in a range of about 6000 nm to about 9,000 nm.

6. The method of claim 3, wherein selecting the one of the first and second laser wavelengths comprises selecting the one of the first and second laser wavelengths based on comparing strengths of the first and second return signals.

7. The method of claim 1, wherein selecting the one of the laser wavelengths comprises selecting the one of the laser wavelengths based on comparing strengths of the plurality of return signals.

8. The method of claim 1,
wherein transmitting the plurality of laser outputs comprises transmitting first, second, and third laser outputs from the LIDAR system, wherein the first laser output has a first laser wavelength, wherein the second laser output has a second laser wavelength different than the first laser wavelength, and wherein the third laser output has a third laser wavelength different than the first and second laser wavelengths,
wherein detecting the respective plurality of return signals comprises detecting a first return signal resulting from the first laser output, detecting a second return signal resulting from the second laser output, and detecting a third return signal resulting from the third laser output,
wherein selecting the one of the plurality of laser wavelengths comprises selecting one of the first, second, and third laser wavelengths based on the first, second, and third return signals, and
wherein performing light detection and ranging comprises performing light detection and ranging using the selected one of the first, second, and third laser wavelengths.

9. A method of operating a tuneable light detection and ranging (LIDAR) system, the method comprising:
performing light detection and ranging using a first laser wavelength of the LIDAR system; and
after performing light detection and ranging using the first laser wavelength, performing light detection and ranging using a second laser wavelength of the LIDAR system, wherein the second wavelength is different than the first laser wavelength.

10. The method of claim 9, wherein performing light detection and ranging using the second wavelength is responsive to a second user input selecting the second laser wavelength.

11. The method of claim 9, wherein performing light detection and ranging using the second laser wavelength is responsive to a return signal of the first wavelength falling below a threshold.

12. The method of claim 9 further comprising:
before performing light detection and ranging using the second wavelength, transmitting first and second laser outputs from the LIDAR system, wherein the first laser output has the first wavelength and the second laser output as the second wavelength;
before performing light detection and ranging using the second wavelength, detecting a first return signal resulting from the first laser output and a second return signal resulting from the second laser output;
wherein performing light detection and ranging using the second laser wavelength is responsive to comparing the first and second return signals.

13. The method of claim 12, wherein the performing light detection and ranging using the second laser wavelength is responsive to a strength of the second return signal exceeding a strength of the first return signal.

14. The method of claim 9, wherein the first wavelength is less than about 5000 nanometers (nm) and the second wavelength is greater than about 6000 nanometers (nm).

15. The method of claim 14, wherein the first wavelength is in a range of about 500 nm to about 4000 nm.

16. The method of claim 14, wherein the second wavelength is in a range of about 6000 nm to about 9,000 nm.

17. A tuneable light detection and ranging (LIDAR) system comprising:
a tuneable laser configured to generate a plurality of laser outputs, wherein each of the plurality of laser outputs has a respective laser wavelength such that each of the plurality of laser outputs has a different laser wavelength;
a detector configured to detect return signals resulting from the plurality of laser outputs; and
a controller coupled with the tuneable laser and with the detector, wherein the controller is configured to control the LIDAR system to,
transmit a plurality of laser outputs from the LIDAR system, wherein each of the plurality of laser outputs has a respective laser wavelength such that each of the plurality of laser outputs has a different laser wavelength,
detect a respective plurality of return signals resulting from the plurality of laser outputs;
select one of the laser wavelengths based on the plurality of return signals, and
after selecting the one of the laser wavelengths, perform light detection and ranging using the selected one of the laser wavelengths.

18. The tuneable LIDAR system of claim 17,
wherein transmitting the plurality of laser outputs comprises transmitting first and second laser outputs from the LIDAR system, wherein the first laser output has a first laser wavelength, and wherein the second laser output has a second laser wavelength different than the first laser wavelength,
wherein detecting the respective return signals comprises detecting a first return signal resulting from the first laser output, and detecting a second return signal resulting from the second laser output,
wherein selecting the one of the plurality of laser wavelengths comprises selecting one of the first and second laser wavelengths based on the first and second return signals, and
wherein performing light detection and ranging comprises performing light detection and ranging using the selected one of the first and second laser wavelengths.

19. A tuneable light detection and ranging (LIDAR) system comprising:
a tuneable laser configured to generate a plurality of laser outputs, wherein each of the plurality of laser outputs has a respective laser wavelength such that each of the plurality of laser outputs has a different laser wavelength;
a detector configured to detect return signals resulting from the plurality of laser outputs; and
a controller coupled with the tuneable laser and with the detector, wherein the controller is configured to control the LIDAR system to,
perform light detection and ranging using a first laser wavelength of the LIDAR system, and
after performing light detection and ranging using the first laser wavelength, perform light detection and ranging using a second laser wavelength of the LIDAR system, wherein the second wavelength is different than the first laser wavelength.

20. The method of claim 19, wherein performing light detection and ranging using the second wavelength is responsive to a second user input selecting the second laser wavelength.
